(19) United States
(12) Patent Application Publication
(10) Pub. No.: US 2024/0322606 A1
(43) Pub. Date: Sep. 26, 2024

(54) PORTABLE CHARGING DEVICE

(71) Applicant: TOYODA GOSEI CO., LTD., Kiyosu-shi (JP)

(72) Inventors: Atsushi SUGIHARA, Kiyosu-shi (JP); Yuki TOKUYAMA, Kiyosu-shi (JP); Kazuhito KAWAMURA, Kiyosu-shi (JP); Takahiro ITO, Kiyosu-shi (JP); Shinichiro FUKI, Kiyosu-shi (JP)

(21) Appl. No.: 18/590,016

(22) Filed: Feb. 28, 2024

(30) Foreign Application Priority Data
Mar. 20, 2023 (JP) 2023-044145

(51) Int. Cl. H02J 50/27; H02J 7/00; H02J 50/70; H02J 50/80; H02J 50/90

(52) U.S. Cl. CPC H02J 50/27; H02J 7/0042; H02J 7/0068; H02J 50/70; H02J 50/80; H02J 50/90

(57) ABSTRACT

A portable charging device includes a housing, a power storage device, a charging interface, and a circuit board. The housing includes a power receiving-side wall and a charging-side wall. The power receiving-side wall and the charging-side wall include two surfaces of the housing that face each other. The charging interface is configured to supply power of the power storage device to an external device. A power receiving antenna is mounted on the circuit board. The power storage device and the charging interface are disposed so as to face the charging-side wall. The circuit board is disposed such that the power receiving antenna faces the power receiving-side wall.

### BACKGROUND

### 1. Field

The present disclosure relates to a portable charging device.

### 2. Description of Related Art

For example, Japanese Patent No. 6725531 discloses a dry cell-type wireless charging battery device. The wireless charging battery device charges an internal rechargeable battery by receiving power transmitted from the outside.

Since multifunctional portable devices and the like predominantly come equipped with dedicated internal batteries, it is challenging to employ the aforementioned dry cell-type wireless charging battery device to such portable devices. On the other hand, there is a need to charge multifunctional portable devices without using outlets or similar power sources inside buildings.

Therefore, portable charging devices have been put into practical use. A portable charging device incorporates a battery and supplies power of the battery to a multifunctional portable device.

The portable charging device is desired to be able to supply sufficient power to the multifunctional portable device. In order for the portable charging device to supply sufficient power to the multifunctional portable device, the portable charging device needs to incorporate a large rechargeable battery. Therefore, the portable charging device is increased in size.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a portable charging device includes a housing, a power storage device, a charging interface, and a circuit board. The housing includes a power receiving-side wall and a charging-side wall. The power receiving-side wall and the charging-side wall include two surfaces of the housing that face each other. The charging interface is configured to supply power of the power storage device to an external device. A power receiving antenna that receives power to be supplied to the power storage device is mounted on the circuit board. The power storage device and the charging interface are disposed so as to face the charging-side wall. The circuit board is disposed such that the power receiving antenna faces the power receiving-side wall.

Other features and aspects will be apparent from the following detailed description, the drawings, and the claims.

### BRIEF DESCRIPTION OF THE DRAWINGS

FIG. 1 is a block diagram showing a configuration of a portable charging device according to a first embodiment.

FIG. 2 is a cross-sectional view showing the portable charging device according to the first embodiment.

FIG. 3 is a plan view showing the interior of the housing of the portable charging device according to the first embodiment.

FIG. 4 is a plan view showing the interior of the housing of the portable charging device according to the first embodiment.

FIG. 5 is a perspective view illustrating an example of a method of using the portable charging device according to the first embodiment.

FIG. 6 is a cross-sectional view showing a portable charging device according to a second embodiment.

FIG. 7 is a plan view showing the interior of the housing of the portable charging device according to the second embodiment.

FIG. 8 is a cross-sectional view showing a portable charging device according to a third embodiment.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, except for operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

### First Embodiment

A first embodiment will now be described with reference to the drawings.

### Functional Units of Portable Charging Device

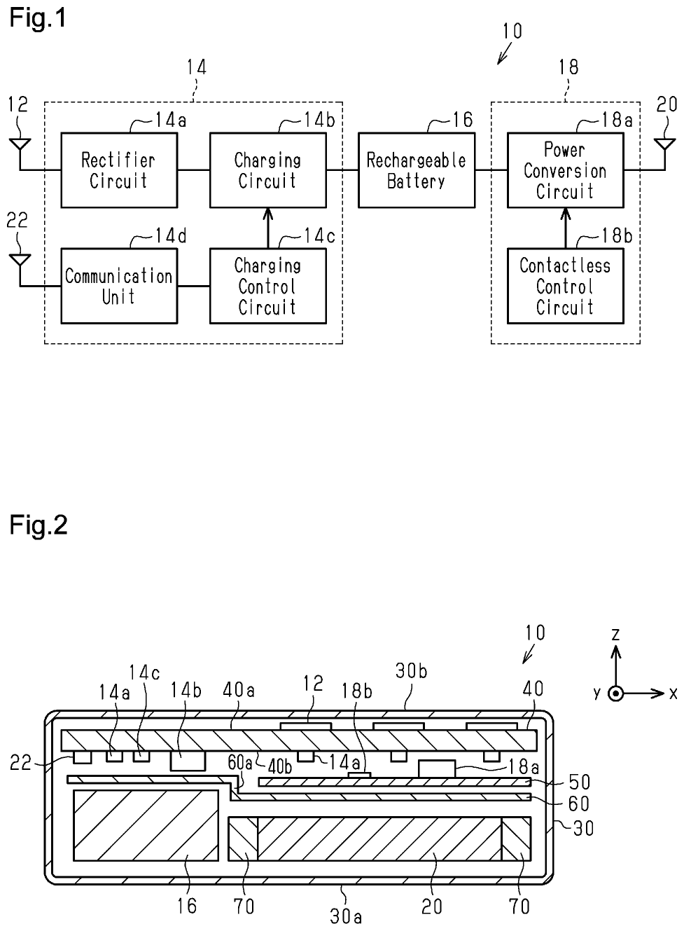

A portable charging device 10 shown in FIG. 1 is a portable battery that supplies power to a multifunctional portable device such as a multifunctional mobile phone in a contactless manner.

The portable charging device 10 receives power supplied from the outside of the portable charging device 10 via power receiving antennas 12. Specifically, the power from the outside is microwave. The frequency band of the microwave used here may be 5.7 to 5.8 GHz. Specifically, the frequency band of the microwave used here may be 5.75 GHz. The frequency band of the microwave used here may be 5.8 GHz. Also, the frequency band of the microwave used here may be 24 GHz. The power received by the power receiving antennas 12 is input to a power receiving circuit 14. The power receiving circuit 14 includes a rectifier circuit 14a, a charging circuit 14b, a charging control circuit 14c, and a communication unit 14d.

The rectifier circuit 14a converts AC power received by the power receiving antennas 12 into DC power. The charging circuit 14b charges a rechargeable battery 16 with the DC power output from the rectifier circuit 14a. The charging control circuit 14c operates the charging circuit 14b so as to control the charging amount to the rechargeable battery 16.

The communication unit 14d communicates with the outside of the portable charging device 10 via a communication antenna 22. For example, the communication unit 14d transmits an identification signal of the portable charging device 10 to the outside via the communication antenna 22. Thus, the portable charging device 10 serves as a beacon. Transmission of the identification signal allows a power supply device outside to detect the presence of the portable charging device 10. The power supply device wirelessly transmits power when detecting the presence of the portable charging device 10. The communication unit 14d may be further configured to exchange information regarding the amount of power supply with the power supply device.

The rechargeable battery 16 is, for example, a lithium-ion rechargeable battery.

A contactless charging circuit 18 is an electromagnetic induction charging circuit that supplies power of the rechargeable battery 16 to an external device via a coil 20. The contactless charging circuit 18 includes a power conversion circuit 18a and a contactless control circuit 18b. The power conversion circuit 18a is a circuit that supplies power of the rechargeable battery 16 to the coil 20. The contactless control circuit 18b controls the amount of power supplied to the external device by operating the power conversion circuit 18a.

### Layout of Portable Charging Device

FIG. 2 shows a cross-sectional configuration of the portable charging device 10.

The portable charging device 10 includes a housing 30. The housing 30 is made of a plastic, for example. The housing 30 has, for example, the shape of a rectangular parallelepiped. In FIG. 2, a z-axis is defined in parallel to a direction orthogonal to two surfaces having the largest area among the six surfaces of the housing 30. The two surfaces face each other. The two surfaces are parallel to an x-axis and a y-axis.

The two surfaces are formed by a charging-side wall 30a and a power receiving-side wall 30b. The charging-side wall 30a forms the surface on the negative side on the z-axis of the portable charging device 10. The rechargeable battery 16, the coil 20, and a magnet 70 are disposed so as to face the charging-side wall 30a. The magnet 70 is used to fix the portable charging device 10 to a multifunctional mobile phone such as a smartphone to which power is supplied.

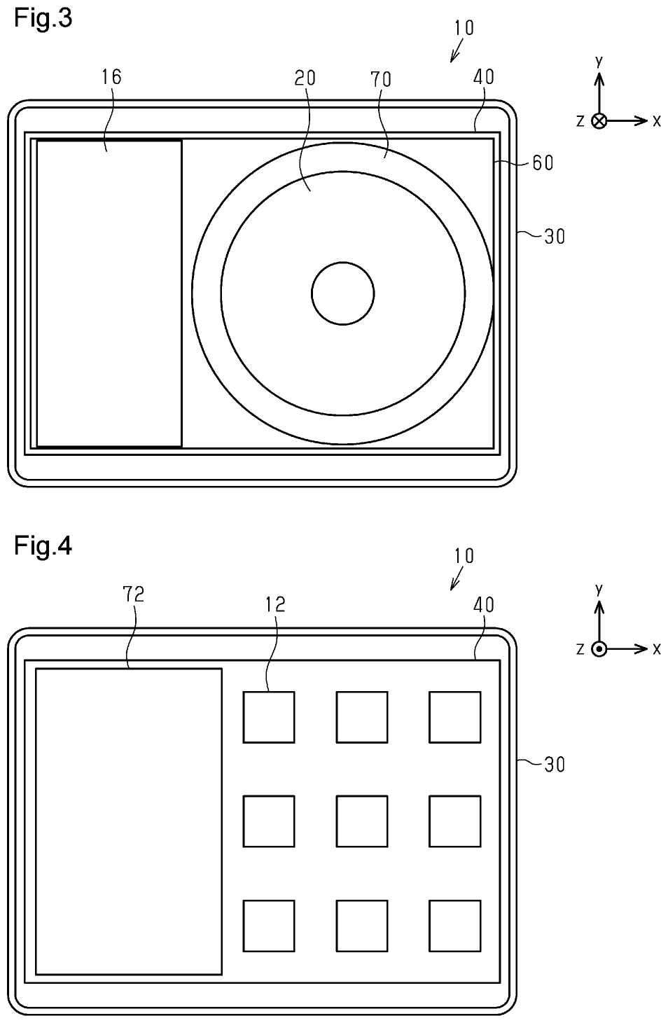

FIG. 3 shows a planar configuration of the interior of the housing 30, as viewed from the negative side on the z-axis. As shown in FIG. 3, the rechargeable battery 16, the coil 20, and the magnet 70 are disposed along the x-axis direction, which is the longitudinal direction of the housing 30. The magnet 70 is disposed so as to surround the outer periphery of the coil 20.

Referring back to FIG. 2, a circuit board 40 is disposed to face the power receiving-side wall 30b. The power receiving antennas 12 are mounted on a first main surface 40a of the circuit board 40, which is a surface on a side facing the power receiving-side wall 30b.

FIG. 4 is a plan view of the circuit board 40 as viewed from the side corresponding to first main surface 40a. As shown in FIG. 4, the power receiving antennas 12 are mounted on the circuit board 40. The power receiving antennas 12 are microstrip antennas. Specifically, the power receiving antennas 12 are mounted in one of two regions obtained by dividing the first main surface 40a in an x-axis direction, which is a longitudinal direction of the circuit board 40. The other one of the divided two regions of the first main surface 40a is a GND region 72. The GND region 72 is a region in which grounds of the power receiving antennas 12 are mounted.

Referring back to FIG. 2, the rectifier circuit 14a is mounted on a second main surface 40b of the circuit board 40, which is opposite to the first main surface 40a. Specifically, the rectifier circuit 14a is mounted on a region in the second main surface 40b onto which the power receiving antennas 12 are vertically projected. In other words, the set of x-axis components and y-axis components in the region in which the rectifier circuit 14a is mounted is included in the set of x-axis components and y-axis components in the region in which the power receiving antennas 12 are mounted.

The charging circuit 14b, the charging control circuit 14c, the communication unit 14d, and the communication antenna 22 are further mounted on the second main surface 40b of the circuit board 40. A region in which the charging circuit 14b, the charging control circuit 14c, the communication unit 14d, and the communication antenna 22 are mounted and a region in which the rectifier circuit 14a is mounted divide the circuit board 40 into two in the x-axis direction, which is the longitudinal direction of the circuit board 40.

The second main surface 40b faces a charging circuit board 50. The charging circuit board 50 has a shorter length in the x-axis direction, which is the longitudinal direction, than that of the circuit board 40. The charging circuit board 50 is disposed to face a region of the circuit board 40 on which the rectifier circuit 14a is mounted. The power conversion circuit 18a and the contactless control circuit 18b are mounted on the charging circuit board 50.

In the housing 30, a region in which the circuit board 40 and the charging circuit board 50 are accommodated and a region in which the rechargeable battery, the coil 20, and the magnet 70 are accommodated are separated from each other by an electromagnetic shield member 60.

The electromagnetic shield member 60 is made of metal. As shown in FIG. 3, a region in the circuit board 40 onto which the electromagnetic shield member 60 is projected is included in the circuit board 40. Referring back to FIG. 2, the electromagnetic shield member 60 includes a bent portion 60a in the vicinity of a boundary between a region facing the rechargeable battery 16 and a region facing the coil 20 and the magnet 70. The bent portion 60a extends in a direction orthogonal to the surface of the electromagnetic shield member 60. Thus, the bent portion 60a forms a step in the z-axis direction between the region facing the rechargeable battery 16 and the region facing the coil 20 and the magnet 70. As shown in FIG. 2, in the electromagnetic shield member 60, the region facing the rechargeable battery 16 is located on the positive side on the z-axis with respect to the region facing the coil 20 and the magnet 70. This configuration is achieved by utilizing the fact that the thickness of the rechargeable battery 16, which is the length in the z-axis direction, is greater than the thickness of the coil 20 and the magnet 70, which is the length in the z-axis direction. Thus, the distance between the circuit board 40 and the electromagnetic shield member 60 is larger in the region in which the electromagnetic shield member 60 faces the charging circuit board 50 than in the region in which the electromagnetic shield member 60 does not face the charging circuit board 50.

### Example of Use

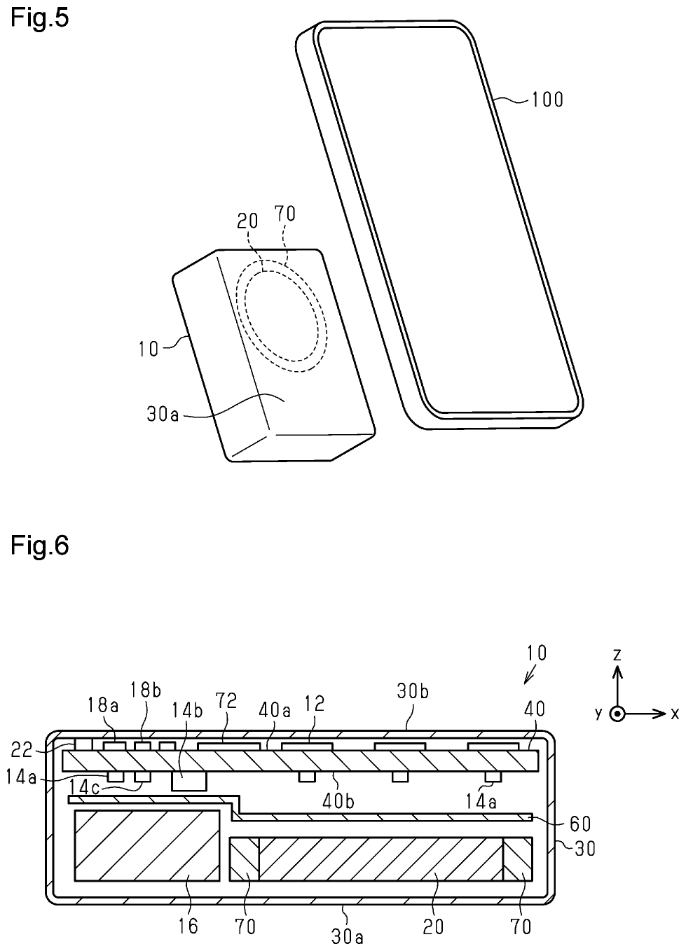

As shown in FIG. 5, the portable charging device 10 charges a multifunctional portable device 100 in a contactless manner by supplying power to the multifunctional portable device 100 in a contactless manner. The charging-side wall 30a of the portable charging device 10 is disposed to face the multifunctional portable device 100. FIG. 5 shows the portable charging device 10 and the multifunctional portable device 100 in a separated state. However, when actually charging the multifunctional portable device 100, it is desirable to bring the charging-side wall 30a of the portable charging device 10 into contact with the multifunctional portable device 100.

Specifically, it is desirable to align the coil 20 with the power receiving coil of the multifunctional portable device 100 when the portable charging device 10 is brought into contact with the multifunctional portable device 100 by the magnet 70. This increases the efficiency of power transmission from the coil 20 to the multifunctional portable device 100.

In this state, a user's hand tends to be put on an end in the longitudinal direction of the multifunctional portable device 100. On the other hand, the power receiving antennas 12 are disposed close to the coil 20 in the longitudinal direction of the portable charging device 10. Accordingly, the power receiving antennas 12 are disposed close to the center of the multifunctional portable device 100. This prevents the surroundings of the power receiving antennas 12 from being covered with the user's hand.

### Operation and Advantages of Present Embodiment

The portable charging device 10 is used to charge the multifunctional portable device 100 or the like. Therefore, the multifunctional portable device 100 is demanded to be supplied with sufficient power. When increasing the capacity of the rechargeable battery 16 to meet this demand, the size of the portable charging device 10 is increased.

In this regard, the portable charging device 10 includes the power receiving antennas 12 and the power receiving circuit 14. This allows the rechargeable battery 16 to be charged with power supplied from the outside. Thus, even if the capacity of the rechargeable battery 16 is reduced, sufficient power can be supplied to the multifunctional portable device 100. This allows the portable charging device 10 to be reduced in size. Particularly, in the portable charging device 10, the rechargeable battery 16 and the coil 20 are arranged side by side along the longitudinal direction. Thus, the portable charging device 10 can be made thinner than in a case in which the rechargeable battery 16 and the coil 20 are arranged side by side in the z-axis direction.

The present embodiment, which has been described above, achieves the following operation and advantages.

(1-1) The magnet 70 is disposed close to the coil 20. Both the magnet 70 and the coil 20 are likely to be thinner than the rechargeable battery 16. This allows the distance between the power receiving-side wall 30b and the structure including the magnet 70 and the coil 20 to be larger than the distance between the rechargeable battery 16 and the power receiving-side wall 30b. Therefore, the portable charging device 10 can be made thinner while increasing the distance between the circuit board 40 and the electromagnetic shield member 60 in the region in which the power receiving antennas 12 are formed.

### Second Embodiment

A second embodiment will now be described with reference to the drawings. The differences from the first embodiment will mainly be discussed.

FIG. 6 shows a cross-sectional configuration of a portable charging device 10 according to the second embodiment. In FIG. 6, the same reference numerals are given to the components that are the same as those in FIG. 2 for the illustrative purposes.

As shown in FIG. 6, the portable charging device 10 does not include the charging circuit board 50. The power conversion circuit 18a and the contactless control circuit 18b are both mounted on the circuit board 40. Specifically, the power conversion circuit 18a and the contactless control circuit 18b are both mounted on the first main surface 40a of the circuit board 40. In the present embodiment, the communication antenna 22 is also mounted on the first main surface 40a of the circuit board 40.

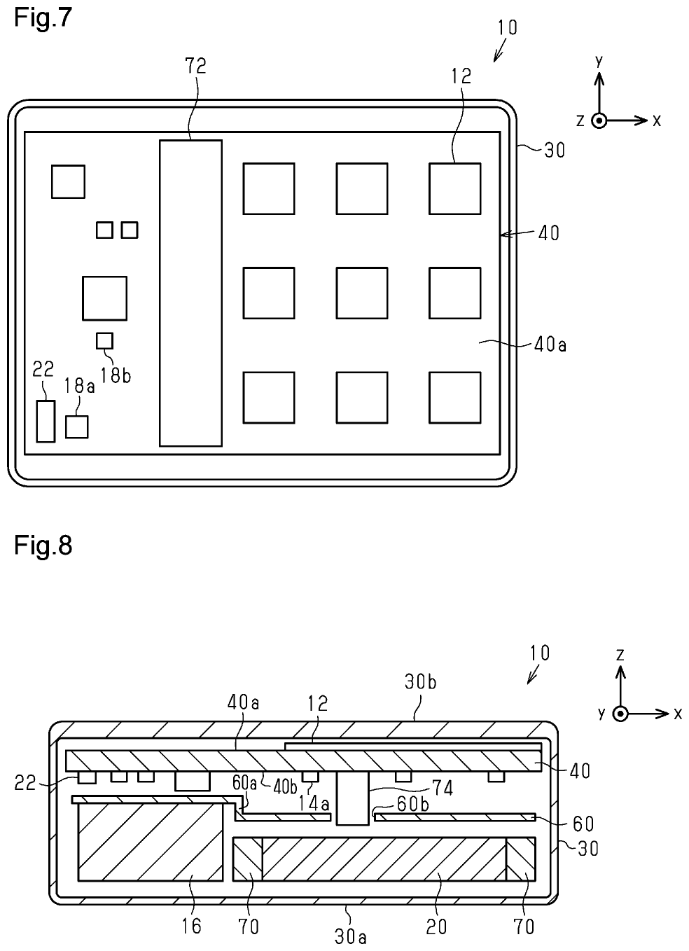

FIG. 7 shows a planar configuration of the circuit board 40 as viewed from the side corresponding to the first main surface 40a. As shown in FIG. 7, the first main surface 40a is divided into three regions in the x-axis direction, which is the longitudinal direction of circuit board 40. The power receiving antennas 12 are mounted in a first region. A second region is a GND region 72. A third region is a region in which the power conversion circuit 18a, the contactless control circuit 18b, and the communication antenna 22 are mounted. As shown in FIG. 7, the GND region 72 is located between the first region and the third region in the x-axis direction.

### Third Embodiment

A third embodiment will now be described with reference to the drawings. The differences from the first embodiment will mainly be discussed.

FIG. 8 shows a cross-sectional configuration of a portable charging device 10 according to the third embodiment. In FIG. 8, the same reference numerals are given to the components that are the same as those in FIG. 2 for the illustrative purposes.

As shown in FIG. 8, the portable charging device 10 does not include the charging circuit board 50. The power conversion circuit 18a and the contactless control circuit 18b are both mounted on the circuit board 40.

A high-power component 74 is mounted on the second main surface 40b of the circuit board 40. The electromagnetic shield member 60 includes an opening 60b. The opening 60b is slightly larger than the cross-section of the high-power component 74 taken along a plane parallel to the circuit board 40. The distal end of the high-power component 74 is inserted into the opening 60b.

The electromagnetic shield member 60 is in contact with the rechargeable battery 16. Specifically, as an example, the electromagnetic shield member 60 is in contact with the entire surface of the rechargeable battery 16 that faces the electromagnetic shield member 60. The surface of the rechargeable battery 16 that faces the electromagnetic shield member 60 is insulated from the electromagnetic shield member 60. This is achieved by, for example, forming the surface of the rechargeable battery 16 that faces the electromagnetic shield member 60 with an insulating member.

The thickness of the power receiving-side wall 30b of the housing 30 is larger than the thickness of the charging-side wall 30a of the housing 30. The thickness is a length in a direction orthogonal to a plane formed by the power receiving-side wall 30b and the charging-side wall 30a. In other words, the thickness is a length in the z-axis direction.

The above-described embodiments include configurations described in the following clauses.

[Clause 1] A portable charging device includes a housing, a power storage device, a charging interface, and a circuit board. The housing includes a power receiving-side wall and a charging-side wall. The power receiving-side wall and the charging-side wall include two surfaces of the housing that face each other. The charging interface is configured to supply power of the power storage device to an external device. A power receiving antenna that receives power to be supplied to the power storage device is mounted on the circuit board. The power storage device and the charging interface are disposed so as to face the charging-side wall. The circuit board is disposed such that the power receiving antenna faces the power receiving-side wall.

With this configuration, the power storage device is charged with the power received by the power receiving antenna. Therefore, sufficient power is supplied to the outside without increasing the capacity of the power storage device. The downsized power storage device and the charging interface are disposed so as to face the charging-side wall of the housing. This allows the portable charging device to be thinner than in the case in which the power storage device and the charging interface overlap with each other.

[Clause 2] The portable charging device according to clause 1 further includes a power receiving circuit. The power receiving circuit is configured to charge the power storage device with power from the power receiving antenna, and is mounted on the circuit board.

With this configuration, the circuit board on which the power receiving antenna is mounted and the circuit board on which the power receiving circuit is mounted are the same circuit board. Therefore, compared to a case in which the circuit board on which the power receiving antenna is mounted and the circuit board on which the power receiving circuit is mounted are different circuit boards from each other, the size of the portable charging device is readily reduced.

[Clause 3] The portable charging device according to clause 1 or clause 2, in which surfaces of the housing formed by the power receiving-side wall and the charging-side wall each have a rectangular shape. The power storage device and the charging interface are disposed along a longitudinal direction of the surface formed by the charging-side wall. The power receiving antenna is disposed closer to a region in the circuit board onto which the charging interface is vertically projected than to a region in the circuit board onto which the power storage device is vertically projected.

With this configuration, the power receiving antenna is disposed closer to one side in the longitudinal direction of the housing. This prevents the power receiving antenna from being covered with a user's hand. Particularly, the portion including the charging interface is less likely to be gripped. It is thus possible to further reliably prevent the power receiving antenna from being surrounded with a hand by disposing the power receiving antenna close to the region in the circuit board onto which the charging interface is vertically projected. This prevents the power supplied from the outside from being attenuated by passing through the hand before reaching the power receiving antenna.

[Clause 4] The portable charging device according to any one of clauses 1 to 3, in which the charging interface is a coil for contactless charging, and the portable charging device further includes an electromagnetic shield member between the circuit board and a structure including the power storage device and the charging interface.

With this configuration, the electromagnetic shield member suppresses the influence of the electromagnetic field generated by the charging interface on the circuit board.

[Clause 5] The portable charging device according to clause 4, in which a distance between a region in the circuit board in which the power receiving antenna is formed and the electromagnetic shield member is larger than a distance between a region in the circuit board in which the power receiving antenna is not formed and the electromagnetic shield member.

With this configuration, the distance between the power receiving antenna and the electromagnetic shield member can be maximized while reducing the thickness of the housing as compared with a case in which the distance between the circuit board and the electromagnetic shield member is constant. This readily improves the performance of the power receiving antenna while reducing the thickness of the housing.

[Clause 6] The portable charging device according to clause 4 or 5, in which the power storage device and the electromagnetic shield member are in contact with each other.

With this configuration, heat generated in the power storage device is efficiently dissipated via the electromagnetic shield member.

[Clause 7] The portable charging device according to any one of clauses 4 to 6, in which the electromagnetic shield member includes an opening, and a prescribed component mounted on the circuit board is inserted into the opening of the electromagnetic shield member.

With this configuration, the housing can be made thinner than in a case in which the electromagnetic shield member faces the prescribed component. Therefore, it is possible to achieve a suitable balance between reduction in the thickness of the housing and the electromagnetic shielding performance of the electromagnetic shield member.

[Clause 8] The portable charging device according to clause 2, in which the circuit board includes a first main surface and a second main surface that are on opposite sides from each other. The first main surface is a surface facing the power receiving-side wall. The power receiving antenna is mounted on the first main surface of the circuit board. The portable charging device further includes a power receiving circuit. The power receiving circuit is configured to charge the power storage device with power received by the power receiving antenna, and is mounted on the circuit board. At least part of the power receiving circuit is mounted on the second main surface.

With this configuration, at least part of the power receiving circuit can be disposed further inside the housing as compared with a case in which at least part of the power receiving circuit is disposed on the first main surface. Therefore, at least part of the power receiving circuit can be protected from external impact as compared with a case in which at least part of the power receiving circuit is disposed on the first main surface.

[Clause 9] The portable charging device according to clause 8, in which the power receiving circuit includes a rectifier circuit that rectifies AC power received by the power receiving antenna, and a charging circuit that charges the power storage device with an output of the rectifier circuit. The rectifier circuit is mounted on a region in the second main surface onto which the power receiving antenna is vertically projected.

With this configuration, the AC power received by the power receiving antenna is converted into DC power by the rectifier circuit. Therefore, the electrical path between the power receiving antenna and the rectifier circuit can be of reduced by providing the power receiving antenna and the rectifier circuit in opposite regions on the circuit board.

[Clause 10] The portable charging device according to any one of clauses 1 to 9 further includes a communication antenna for communication with an outside of the portable charging device. The circuit board has a rectangular shape. The communication antenna is mounted on the circuit board at a position, in a longitudinal direction of the circuit board, close to an end on a side opposite to a side at which the power receiving antenna is mounted.

With this configuration, since the communication antenna is disposed close to an end in the longitudinal direction of the circuit board, it is possible to prevent the surroundings of the communication antenna from being covered with a user's hand as compared with a case in which the communication antenna is disposed at the center in the longitudinal direction. This prevents the intensity of the radio wave received by the communication antenna from becoming excessively low.

[Clause 11] The portable charging device according to any one of clauses 1 to 10, in which the circuit board includes a first main surface and a second main surface that are on opposite sides from each other. The first main surface is a surface facing the power receiving-side wall. The power receiving antenna is mounted on the first main surface of the circuit board. Among components mounted on the circuit board, a component having a largest amount of protrusion from the circuit board protrudes from the second main surface.

The amount by which the power receiving antenna and the ground of the power receiving antenna protrude from the circuit board is small. Therefore, forming the power receiving antenna on the first main surface means mounting a member having a small amount of protrusion on the first main surface. Since the component having the largest amount of protrusion protrudes from the second main surface, the distance between the first main surface and the power receiving-side wall is reduced. Therefore, it is possible to increase the space between the circuit board and the charging-side wall while reducing the thickness of the portable charging device.

[Clause 12] The portable charging device according to any one of clauses 1 to 11, in which the power receiving antenna is a microstrip antenna, and a ground of the power receiving antenna is mounted on the circuit board between a region in which circuit components are mounted and a region in which the power receiving antenna is mounted.

In this configuration, the ground of the power receiving antenna is mounted between the region in which the circuit components are mounted and the region in which the power receiving antenna is mounted. This increases the power receiving efficiency of the power receiving antenna.

[Clause 13] The portable charging device according to any one of clauses 1 to 12, in which a number of components, except for the power receiving antenna, mounted on a surface of the circuit board opposite to a surface on which the power receiving antenna is mounted is larger than a number of components, except for the power receiving antenna, mounted on the surface of the circuit board on which the power receiving antenna is mounted.

This configuration provides more space on the surface on which the power receiving antenna is mounted compared to a case in which the number of components, other than the power receiving antenna, mounted on the surface on which the power receiving antenna is mounted is greater than the number of components, other than the power receiving antenna, mounted on the opposite surface. This secures space for the ground of the power receiving antenna on the surface on which the power receiving antenna is mounted.

[Clause 14] The portable charging device according to any one of clauses 1 to 13, in which the charging interface is a coil for contactless charging. The portable charging device further includes a power receiving circuit and a contactless charging circuit. The power receiving circuit is configured to charge the power storage device with power from the power receiving antenna. The contactless charging circuit is configured to supply power of the power storage device to an outside via the charging interface. The power receiving circuit and the contactless charging circuit are mounted on the circuit board.

With this configuration, since the power receiving circuit and the contactless charging circuit are mounted on the same circuit board, the number of circuit boards of the portable charging device is reduced as compared with a case in which the power receiving circuit and the contactless charging circuit are mounted on different circuit boards. This reduces the costs as compared with the case in which the power receiving circuit and the contactless charging circuit are mounted on separate circuit boards.

[Clause 15] The portable charging device according to any one of clauses 1 to 14, in which a magnet for fixing the portable charging device to a recipient of power supply from the power storage device is provided so as to face the charging-side wall, and a thickness of a portion of the housing that forms the power receiving-side wall is greater than a thickness of a portion of the housing that forms the charging-side wall.

With this configuration, since the thickness of the charging-side wall is smaller than the thickness of the power receiving-side wall, the portable charging device is more reliably fixed to the recipient of power supply by the magnet than in a case in which the thickness of the charging-side wall is equal to the thickness of the power receiving-side wall. In addition, since the thickness of the power receiving-side wall is greater than the thickness of the charging-side wall, the components mounted on the circuit board are protected more reliably than in a case in which the thickness of the power receiving-side wall is less than or equal to the thickness of the charging-side wall.

### Correspondence

The correspondence between the items in the above-described embodiment and the items described in clauses 1 to 15 is as follows. Below, the correspondence is shown for each of the numbers in the examples described in clauses 1 to 15. [1] The power storage device corresponds to the rechargeable battery 16. The charging interface corresponds to the coil 20. [2] Clause 2 corresponds to the configuration in which the rectifier circuit 14a, the charging circuit 14b, the charging control circuit 14c, and the communication unit 14d are mounted on the circuit board 40. [3] The longitudinal direction corresponds to the x-axis direction. The region in the circuit board onto which the power storage device is vertically projected corresponds to a region in the circuit board 40 in which the x-axis coordinate components and the y-axis coordinate components are the same as the x-axis coordinate components and the y-axis coordinate components of the rechargeable battery 16. The region in the circuit board onto which the charging interface is vertically projected corresponds to a region in the circuit board 40 in which the x-axis coordinate components and the y-axis coordinate components are the same as the x-axis coordinate components and the y-axis coordinate components of the coil 20. [4] Clause 4 corresponds to the configuration in which the electromagnetic shield member 60 is provided between the circuit board 40 and the structure including the rechargeable battery 16 and the coil 20 in the z-axis direction. [5] Clause 5 corresponds to the configuration in which, as shown in FIG. 2 and the like, the z-axis coordinate of the electromagnetic shield member 60 on the positive side on the x-axis with respect to the bent portion 60a is smaller than the z-axis coordinate of the electromagnetic shield member 60 on the negative side on the x-axis with respect to the bent portion 60a. [6] Clause 6 corresponds to FIG. 8. [7] The prescribed component corresponds to the high-power component 74. [8, 9] Clauses 8 and 9 correspond to the configuration in which the rectifier circuit 14a is mounted in the region in the second main surface 40b onto which the power receiving antennas 12 are vertically projected. The longitudinal direction corresponds to the x-axis direction. The “end on a side opposite” corresponds to an end of the circuit board 40 on the negative side on the x-axis. The component having a largest amount of protrusion corresponds to the charging circuit 14b in FIGS. 2 and 6 and the high-power component 74 in FIG. 8. The ground corresponds to the GND region 72. Clause 13 corresponds to the configuration in which electronic components other than the power receiving antennas 12 are mounted on the second main surface 40b in FIGS. 2 and 8. Clause 14 corresponds to FIGS. 6 and 8. Clause 15 corresponds to FIG. 8.

### Other Embodiments

The above-described embodiments may be modified as follows. The above-described embodiments and the following modifications can be combined as long as the combined modifications remain technically consistent with each other.

### Modification of Power Storage Device

The rechargeable battery is not limited to a lithium-ion rechargeable battery. The rechargeable battery may be a nickel metal-hydride rechargeable battery, for example. The power storage device does not necessarily need to be a rechargeable battery. The power storage device may be, for example, a capacitor.

### Modification of Charging Interface

The charging interface is not limited to the coil 20. For example, the portable charging device 10 may be a device that supplies power to the multi functional portable device 100 in a wired manner, and the charging interface may be a device for supplying power in a wired manner. In addition, the charging interface may be a device for supplying power both with the coil 20 and in a wired manner. In this case, for example, when the device for supplying power in a wired manner is a circuit mounted on a circuit board, the member disposed to face the charging-side wall 30a may be only the coil 20 of the charging interface.

### Modification of Communication Antenna

Although FIG. 6 shows a configuration in which the communication antenna 22 is mounted on the first main surface 40a, the communication antenna 22 may be mounted on the second main surface 40b.

Although FIGS. 2 and 8 show configurations in which the communication antenna 22 is mounted on the second main surface 40b, the communication antenna 22 may be mounted on the first main surface 40a.

In FIG. 2, the communication antenna 22 may be mounted on the charging circuit board 50 instead of being mounted on the second main surface 40b.

The use of the communication antenna 22 is not limited to the use of causing the portable charging device 10 to function as a beacon.

### Modification of Charging Circuit Board

FIG. 2 illustrates an example in which the power conversion circuit 18a and the contactless control circuit 18b are mounted on the surface of the charging circuit board 50 that faces the circuit board 40, the present disclosure is not limited to this. For example, at least one of the power conversion circuit 18a and the contactless control circuit 18b may be mounted on the surface of the charging circuit board 50 on a side opposite to the surface facing the circuit board 40.

The length of the charging circuit board 50 in the longitudinal direction does not necessarily need to be shorter than the length of the circuit board 40 in the longitudinal direction. For example, a thinner rechargeable battery 16 may be used, and the charging circuit board 50 and the electromagnetic shield member 60 may be disposed to face each other without providing the bent portion 60a in the electromagnetic shield member 60. In this case, the circuit board 40 faces the electromagnetic shield member 60 with the charging circuit board 50 in between also at the end on the negative side on the x-axis.

### Modification of Electromagnetic Shield Member 60

FIG. 3 illustrates an example in which the x-axis coordinate components and the y-axis coordinate components of the electromagnetic shield member 60 are included in the x-axis coordinate components and the y-axis coordinate components of the circuit board 40, but the present disclosure is not limited to this. For example, the x-axis coordinate components and the y-axis coordinate components of the circuit board 40 may be included in the x-axis coordinate components and the y-axis coordinate components of the electromagnetic shield member 60.

### Modifications of Power Receiving-Side Wall and Charging-Side Wall

The surfaces of the power receiving-side wall 30b and the charging-side wall 30a that are parallel to the x-axis and the y-axis do not necessarily need to have rectangular shapes. For example, those surfaces may have square shapes.

In FIGS. 2 and 6, the thickness of the power receiving-side wall 30b may be greater than the thickness of the charging-side wall 30a as illustrated in FIG. 8.

In FIG. 8 and the like, the thickness of the power receiving-side wall 30b may be less than or equal to the thickness of the charging-side wall 30a.

### Modification of Layout of Power Receiving Circuit 14

The member mounted on the region in the second main surface 40b onto which the power receiving antennas 12 are vertically projected is not limited to the rectifier circuit 14a. The member mounted on the region onto which the power receiving antennas 12 are vertically projected may be, for example, the charging circuit 14b. Further, the member mounted on the region onto which the power receiving antennas 12 are vertically projected may be the rectifier circuit 14a and the charging circuit 14b.

### Modification of Layout of Power Receiving Antennas 12

The power receiving antennas 12 does not necessarily need to be disposed on the positive side on the x-axis. For example, the power receiving antennas 12 may be mounted in a central portion of the circuit board 40.

### Modification of Magnet

A magnet does not necessarily need to be disposed to face the charging-side wall 30a. For example, the multifunctional portable device 100 may be configured to be supplied with power in a wired manner, and the magnet may be disposed to face the power receiving-side wall 30b.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A portable charging device, comprising:
a housing;
a power storage device;
a charging interface; and
a circuit board, wherein
the housing includes a power receiving-side wall and a charging-side wall,
the power receiving-side wall and the charging-side wall include two surfaces of the housing that face each other,
the charging interface is configured to supply power of the power storage device to an external device,
a power receiving antenna that receives power to be supplied to the power storage device is mounted on the circuit board,
the power storage device and the charging interface are disposed so as to face the charging-side wall, and
the circuit board is disposed such that the power receiving antenna faces the power receiving-side wall.

2. The portable charging device according to claim 1, further comprising a power receiving circuit,
wherein the power receiving circuit is configured to charge the power storage device with power from the power receiving antenna, and is mounted on the circuit board.

3. The portable charging device according to claim 1, wherein
surfaces of the housing formed by the power receiving-side wall and the charging-side wall each have a rectangular shape,
the power storage device and the charging interface are disposed along a longitudinal direction of the surface formed by the charging-side wall, and
the power receiving antenna is disposed closer to a region in the circuit board onto which the charging interface is vertically projected than to a region in the circuit board onto which the power storage device is vertically projected.

4. The portable charging device according to claim 1, wherein
the charging interface is a coil for contactless charging, and
the portable charging device further comprises an electromagnetic shield member between the circuit board and a structure including the power storage device and the charging interface.

5. The portable charging device according to claim 4, wherein a distance between a region in the circuit board in which the power receiving antenna is formed and the electromagnetic shield member is larger than a distance between a region in the circuit board in which the power receiving antenna is not formed and the electromagnetic shield member.

6. The portable charging device according to claim 4, wherein the power storage device and the electromagnetic shield member are in contact with each other.

7. The portable charging device according to claim 4, wherein
the electromagnetic shield member includes an opening, and
a prescribed component mounted on the circuit board is inserted into the opening of the electromagnetic shield member.

8. The portable charging device according to claim 2, wherein
the circuit board includes a first main surface and a second main surface that are on opposite sides from each other,
the first main surface is a surface facing the power receiving-side wall,
the power receiving antenna is mounted on the first main surface of the circuit board, and
at least part of the power receiving circuit is mounted on the second main surface.

9. The portable charging device according to claim 8, wherein
the power receiving circuit includes:
a rectifier circuit that rectifies AC power received by the power receiving antenna; and
a charging circuit that charges the power storage device with an output of the rectifier circuit, and
the rectifier circuit is mounted on a region in the second main surface onto which the power receiving antenna is vertically projected.

10. The portable charging device according to claim 1, further comprising a communication antenna for communication with an outside of the portable charging device, wherein
the circuit board has a rectangular shape, and
the communication antenna is mounted on the circuit board at a position, in a longitudinal direction of the circuit board, close to an end on a side opposite to a side at which the power receiving antenna is mounted.

11. The portable charging device according to claim 10, wherein
the circuit board includes a first main surface and a second main surface that are on opposite sides from each other,
the first main surface is a surface facing the power receiving-side wall,
the power receiving antenna is mounted on the first main surface of the circuit board, and
among components mounted on the circuit board, a component having a largest amount of protrusion from the circuit board protrudes from the second main surface.

12. The portable charging device according to claim 1, wherein
the power receiving antenna is a microstrip antenna, and
a ground of the power receiving antenna is mounted on the circuit board between a region in which circuit components are mounted and a region in which the power receiving antenna is mounted.

13. The portable charging device according to claim 1, wherein a number of components, except for the power receiving antenna, mounted on a surface of the circuit board opposite to a surface on which the power receiving antenna is mounted is larger than a number of components, except for the power receiving antenna, mounted on the surface of the circuit board on which the power receiving antenna is mounted.

14. The portable charging device according to claim 1, wherein
the charging interface is a coil for contactless charging,
the portable charging device further comprises a power receiving circuit and a contactless charging circuit,
the power receiving circuit is configured to charge the power storage device with power from the power receiving antenna,
the contactless charging circuit is configured to supply power of the power storage device to an outside via the charging interface, and
the power receiving circuit and the contactless charging circuit are mounted on the circuit board.

15. The portable charging device according to claim 1, wherein
a magnet for fixing the portable charging device to a recipient of power supply from the power storage device is provided so as to face the charging-side wall, and
a thickness of a portion of the housing that forms the power receiving-side wall is greater than a thickness of a portion of the housing that forms the charging-side wall.
